(19) United States
(12) Patent Application Publication
(10) Pub. No.: US 2025/0348485 A1
(43) Pub. Date: Nov. 13, 2025

(54) GENERATIVE MODEL BASED DECOMPOSITION OF INPUT QUERY INTO SUB-QUERIES AND GENERATION OF COMPREHENSIVE RESPONSE BASED ON RESPONSES TO SUB-QUERIES

(71) Applicant: GOOGLE LLC, Mountain View, CA (US)

(72) Inventors: Chinmay Kulkarni, Atlanta, GA (US); Kai Zhao, Jersey City, NJ (US); Kushal Majmundar, Mountain View, CA (US); Ester Hlavnova, New York, NY (US); Mukund Harakere Sridhar, Mountain View, CA (US); Aarush Selvan, New York, NY (US); Rupashree Bhattacharya, Santa Clara, CA (US); Rushin Shah, Fremont, CA (US); Shachi Paul, Fremont, CA (US); Nihal Sandeep Balani, New York, NY (US); Jai Lakhanpal, New York, NY (US); Shubham Gupta, Sunnyvale, CA (US); Altaf Rahman, South San Francisco, CA (US); Sonal Gupta, Sunnyvale, CA (US)

(21) Appl. No.: 19/202,612

(22) Filed: May 8, 2025

Related U.S. Application Data
(60) Provisional application No. 63/645,915, filed on May 12, 2024.

(51) Int. Cl. G06F 16/2453

(52) U.S. Cl. CPC G06F 16/24535; G06F 16/24542

(57) ABSTRACT

Some implementations relate to utilization of generative model(s) (e.g., large language model(s)) in selectively generating a comprehensive response for an input query, where the comprehensive response is generated based on multiple sub-query responses, and where the multiple sub-query responses are generated based on multiple sub-queries decomposed from the input query and corresponding tools for the sub-queries. Generating the comprehensive response based on the multiple sub-query responses integrates, into the comprehensive response, detailed information and/or actionable content that are responsive to the multiple sub-queries decomposed from the input query.

### BACKGROUND

Various generative models have been proposed that can be used to process natural language (NL) content and/or other input(s) (e.g., image(s) that accompany NL content), to generate output that reflects generative content (e.g., NL content, image(s)) that is responsive to the input(s). For example, large language models (LLM(s)) have been developed that can be used to process NL content and/or other input(s), to generate LLM output that reflects NL content and/or other content that is responsive to the input(s). For instance, an LLM can be used to process NL content of “I want to replace my thermostat with a smart thermostat and my doorbells with smart doorbells by the end of the month”, to generate LLM output. The LLM output can reflect, for example, a summary of smart thermostat features, smart doorbell features, and an overview of smart thermostat products and smart doorbell products. The LLM output can be generated, for example, based on intrinsic learned parameters of the LLM itself. However, current utilizations of generative models suffer from one or more

drawbacks. For example, in the example of the previous paragraph the LLM output can reflect information that is useful to the user and that serves as a good starting point for the user to perform further computer actions directed toward replacing their thermostat and doorbell with smart thermostats and doorbells. The further computer actions can include exploring the different product options, their prices, expected delivery dates, installation options, etc.

However, to perform such further computer actions the user must provide extensive additional inputs, such as further NL inputs to the LLM, searches in search engine(s), interaction(s) with website(s) to determine prices and expected delivery dates, phone call(s) to supplier(s) and/or to installer(s), etc. In addition to the extensive additional inputs taking extensive clock on the wall time, they often require switching between various applications and/or interfaces and require consuming and collating dense information into an actionable format. This results in extensive utilization of client device resources, such as battery resources of a mobile phone, laptop, or other battery powered client device. Further, constrained screen sizes and/or limited input modalities of mobile phones or other battery powered devices can prolong the duration of consuming and collating dense information into a utilizable format. In view of these and other considerations, it can be the case that the user is unable to perform such further computer actions without significantly depleting limited battery resources of a client device. For example, if the state of charge of a battery of a client device is low, the user may be unable to perform the further computer actions before the state of charge is fully depleted.

More generally, LLMs and other generative models can be utilized as part of a human to computer dialog, generating responses to inputs/queries provided by a user of the application. However, complex input queries, such as queries that implicitly and/or explicitly contain multiple sub-queries, can be difficult for the LLM to handle effectively. For example, an LLM response to a complex input query will often be underspecified, omitting information that is responsive to one or more sub-queries that are at least implicitly indicated by the complex input query. This can require the user to guide the human to computer dialog and to proactively provide additional inputs to the LLM over many additional dialog turns.

### SUMMARY

Implementations described herein can serve to reduce (or eliminate) the utilization of client device resources in providing additional follow-up input(s) responsive to a response that is generated utilizing generative model(s) responsive to an input query provided via the client device. For example, reducing the extent of follow-up input(s) provided to the generative model(s), to search engine(s), to web browser(s) (e.g., in navigating web page(s), and/or to other application(s) or system(s). Implementations disclosed herein can additionally or alternatively serve to proactively guide a human to computer dialog and/or to lessen a quantity of dialog turns required for responding to an input query.

More particularly, implementations disclosed herein are directed to utilization of generative model(s) (e.g., LLM(s) and/or other generative model(s)) in selectively generating a comprehensive response for an input query, where the comprehensive response is generated based on multiple sub-query responses, and where the multiple sub-query responses are generated based on multiple sub-queries decomposed from the input query and corresponding tools for the sub-queries. Generating the comprehensive response based on the multiple sub-query responses integrates, into the comprehensive response, detailed information and/or actionable content that are responsive to the multiple sub-queries decomposed from the input query.

Some implementations include receiving an input query that is generated based on user interface input at a client device. The input query is decomposed to determine sub-queries and to determine corresponding tools to utilize in processing the sub-queries. Each sub-query is processed using the corresponding tool(s) for the sub-query to generate sub-query response(s). An initial comprehensive response is generated using the sub-query responses.

In some implementations, prior to generating the initial comprehensive response, one or more (e.g., all) of the sub-queries and/or one or more of the corresponding tool(s) can be rendered (e.g., graphically) at a user interface output device of the client device. In some of those implementations, a corresponding user can provide user interface input that is directed to such rendering to alter and/or remove one or more of the sub-queries and/or the corresponding tool(s). For example, a user can remove one of the sub-queries by swiping it away, providing natural language input of “remove [natural language description of sub-query]”, or other removing input. Removing a sub-query or a tool can result in the sub-query or the tool no longer being utilized in generating the initial comprehensive response. As another example, a user can alter one of the sub-queries by providing natural language input of “change [natural language description of sub-query] by [natural language description of change]” or other altering input. Altering a sub-query or a tool can result in the altered sub-query or altered tool being utilized in generating the initial comprehensive response in lieu of the original sub-query or original tool.

Prior to causing the initial comprehensive response to be rendered at the client device responsive to the user interface input, it is determined whether the initial comprehensive response is responsive to the input query. For example, the initial comprehensive response and the input query can be processed, using an LLM (or other generative model), and optionally along with the sub-queries and/or the corresponding tool(s) utilized to generate the initial comprehensive response, to generate a critique response that indicates whether the initial comprehensive response is responsive to the input query.

If it is determined, based on the critique response, that the initial comprehensive response is responsive, the initial comprehensive response is then caused to be rendered at the client device as responsive to the input query. However, if it is determined that the initial comprehensive response is not responsive to the input query, the initial comprehensive response is not rendered at the client device and, instead, a refined comprehensive response is generated. The refined comprehensive response is based on further sub-query response(s) that are generated based on one or more further sub-queries and corresponding tool(s). For example, the one or more further sub-queries and corresponding tool(s) can be determined based on processing the generated critique response, then the one or more further sub-queries and corresponding tool(s) utilized to generate the further sub-query response(s). The refined comprehensive response can then be generated based on processing the further sub-query response(s) and the initial comprehensive response and/or the initial sub-query response(s). The refined comprehensive response can then be caused to be rendered at the client device in response to the input query.

Rendering of the refined comprehensive response can optionally be contingent on determining that the refined comprehensive response is responsive to the input query. For example, the refined comprehensive response and the input query can be processed, using an LLM, and optionally along with the sub-queries, the further sub-queries, and/or the corresponding tool(s), to generate a further critique response that indicates whether the refined comprehensive response is responsive to the input query. The further critique response can be used to determine whether the refined critique response is responsive to the input query. If not, a yet further refined comprehensive response can be generated.

In these and other manners, refined comprehensive response(s) can be selectively generated to ensure that a comprehensive response that is initially rendered responsive to an input query is responsive to most or all facets of the input query, while preventing generation of refined comprehensive response(s) when earlier generated comprehensive response(s) are determined to be responsive to the input query. Accordingly, implementations seek to balance the conservation of client device resources that can be achieved by a comprehensive response that is responsive to the input query, with the further resources (often server-side) that are needed to generate refined comprehensive response(s)—while also seeking to mitigate occurrences of over-specified comprehensive responses.

In some implementations, an LLM or other generative model can include at least hundreds of millions of parameters. In some of those implementations, the LLM or other generative model includes at least billions of parameters, such as one hundred billion or more parameters. In some additional or alternative implementations, an LLM is a sequence-to-sequence model, is Transformer-based, can include an encoder and/or a decoder, can process multi-modal input(s) (e.g., natural language and image(s)), and/or can generate multi-modal output(s). One non-limiting example of an LLM is GOOGLE'S Pathways Language Model (PaLM). Another non-limiting example of an LLM is GOOGLE'S Language Model for Dialog Applications (LaMDA). Another non-limiting example of an LLM is GOOGLE'S multi-modal Gemini model. However, it should be noted that the LLMs described herein are one example of generative machine learning models and are not intended to be limiting.

The preceding is presented as an overview of only some implementations disclosed herein. These and other implementations are disclosed in additional detail herein.

### BRIEF DESCRIPTION OF THE DRAWINGS

FIG. 1 depicts a block diagram of an example environment that demonstrates various aspects of the present disclosure, and in which some implementations disclosed herein can be implemented.

FIG. 2 depicts a flowchart that illustrates an example method of decomposing an input query into sub-queries and generating a comprehensive response based on responses to those subqueries.

FIG. 2A depicts a flowchart that illustrates an example of block 252 of FIG. 2.

FIG. 2B depicts a flowchart that illustrates an example of block 254 of FIG. 2.

FIG. 2C depicts a flowchart that illustrates an example of block 260 of FIG. 2.

FIG. 2D depicts a flowchart that illustrates an example of block 270 of FIG. 2.

FIG. 3A illustrates an example client device, an example input query, and an example non-comprehensive response to the input query.

FIG. 3B1 illustrates the example client device, an example input query, an example specification prompt, an example reply to the specification prompt, and an example notification that characterizes that there will be a time delay before a comprehensive response is provided.

FIG. 3B2 illustrates the example client device rendering a comprehensive response subsequent to the interaction of FIG. 3B1.

FIG. 4 depicts an example architecture of a computing device, in accordance with various implementations.

### DETAILED DESCRIPTION

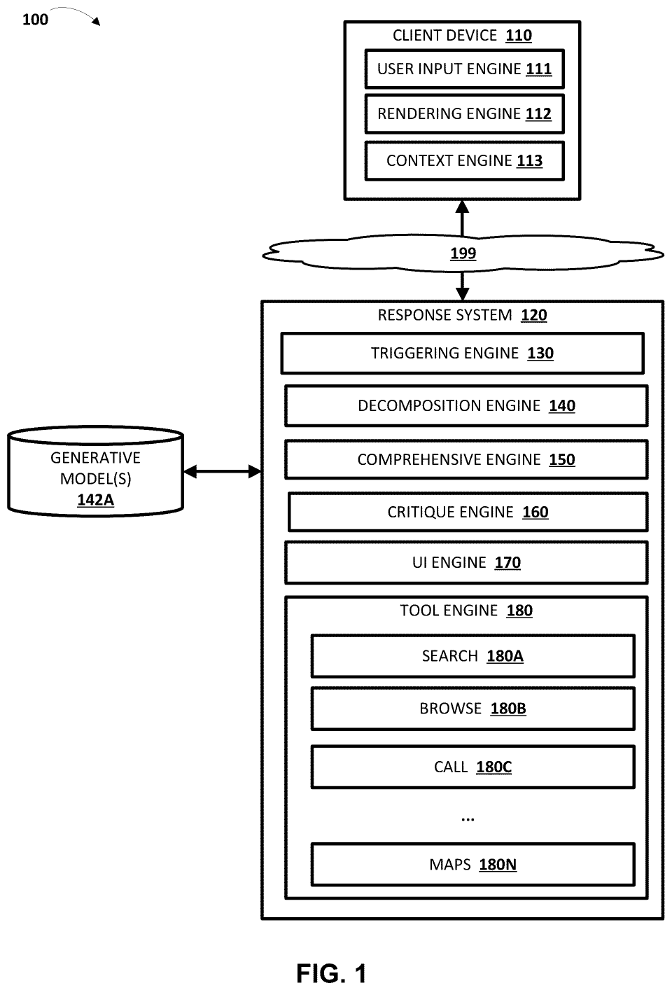

Turning now to FIG. 1, a block diagram of an example environment 100 that demonstrates various aspects of the present disclosure, and in which implementations disclosed herein can be implemented is depicted. The example environment 100 includes a client device 110 and a response system 120. The client device 110 includes a user input engine 111 that can receive spoken, typed, and/or other user interface inputs that can be included as part of an input query provided to the response system 120. The client device 110 also includes a rendering engine 112 that can cause visual and/or audible rendering of comprehensive responses, non-comprehensive responses, clarification prompt(s), and/or other outputs from response system 120. The client device 110 also includes a context engine 113 that can provide, as part of an input query provided to the response system 120, various local context information such as location, currently executing application(s) at the client device 110, content from currently executing application(s), content from locally stored filed at the client device 110, and/or other context information. Although illustrated separately from client device 110 and coupled with client device via network(s) 199, in some implementations all or aspects of response system 120 can be implemented on the client device 110, optionally as part of a cohesive system with one or more of engines 111, 112, and 113.

In additional or alternative implementations, all or aspects of the response system 120 can be implemented remotely from the client device 110 as depicted in FIG. 1 (e.g., at remote server(s)). In those implementations, the client device 110 and the response system 120 can be communicatively coupled with each other network(s) 199, such as one or more wired or wireless local area networks (“LANs,” including Wi-Fi LANs, mesh networks, Bluetooth, near-field communication, etc.) or wide area networks (“WANs”, including the Internet).

The client device 110 can be, for example, one or more of: a desktop computer, a laptop computer, a tablet, a mobile phone, a computing device of a vehicle (e.g., an in-vehicle communications system, an in-vehicle entertainment system, an in-vehicle navigation system), a standalone interactive speaker (optionally having a display), a smart appliance such as a smart television, and/or a wearable apparatus of the user that includes a computing device (e.g., a watch of the user having a computing device, glasses of the user having a computing device, a virtual or augmented reality computing device). Additional and/or alternative client devices may be provided.

Further, the client device 110 and/or the response system 120 can include one or more memories for storage of data and/or software applications, one or more processors for accessing data and executing the software applications, and/or other components that facilitate communication over one or more of the networks 199. In some implementations, one or more of the software applications can be installed locally at the client device 110, whereas in other implementations one or more of the software applications can be hosted remotely (e.g., by one or more servers) and can be accessible by the client device 110 over one or more of the networks 199.

Although aspects of FIG. 1 are illustrated or described with respect to a single client device having a single user, it should be understood that is for the sake of example and is not meant to be limiting. For example, one or more additional client devices of a user and/or of additional user(s) can also implement the techniques described herein. For instance, the client device 110, the one or more additional client devices, and/or any other computing devices of a user can form an ecosystem of devices that can employ techniques described herein. These additional client devices and/or computing devices may be in communication with the client device 110 (e.g., over the network(s) 199). As another example, a given client device can be utilized by multiple users in a shared setting (e.g., a group of users, a household).

Response system 120 is illustrated as including a triggering engine 130, a decomposition engine 140, a comprehensive engine 150, a critique engine 160, a UI engine 170, and a tool engine 180. The engines can each interface with one or more generative models 142A, which can be included as part of the response system 120 and/or communicatively coupled with the response system 120 (e.g., accessible via application programming interface(s)). Some of the engines can be omitted in various implementations. In some implementations, the engines of the response system 120 are distributed across one or more computing systems.

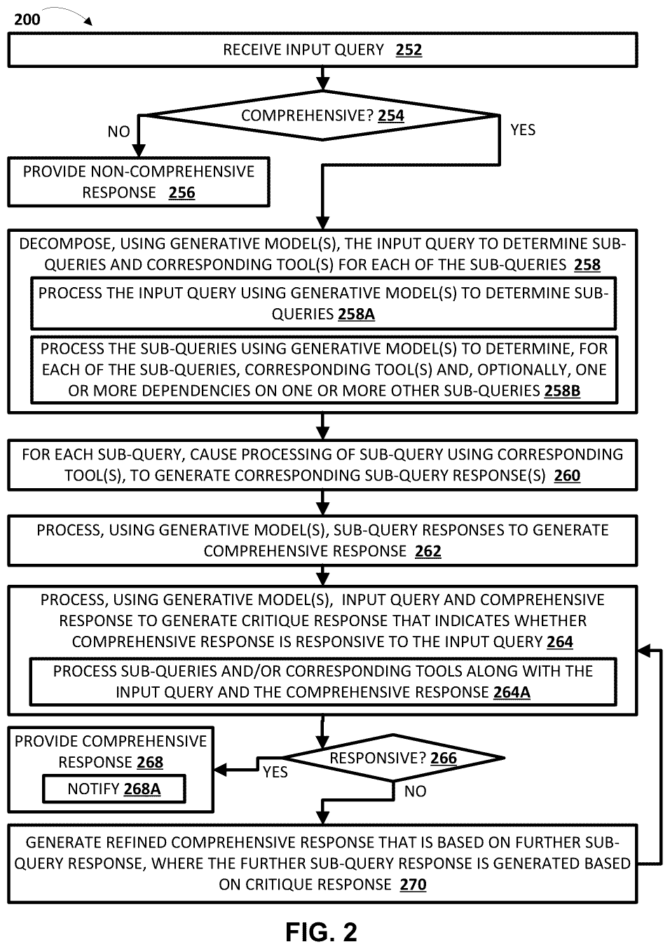

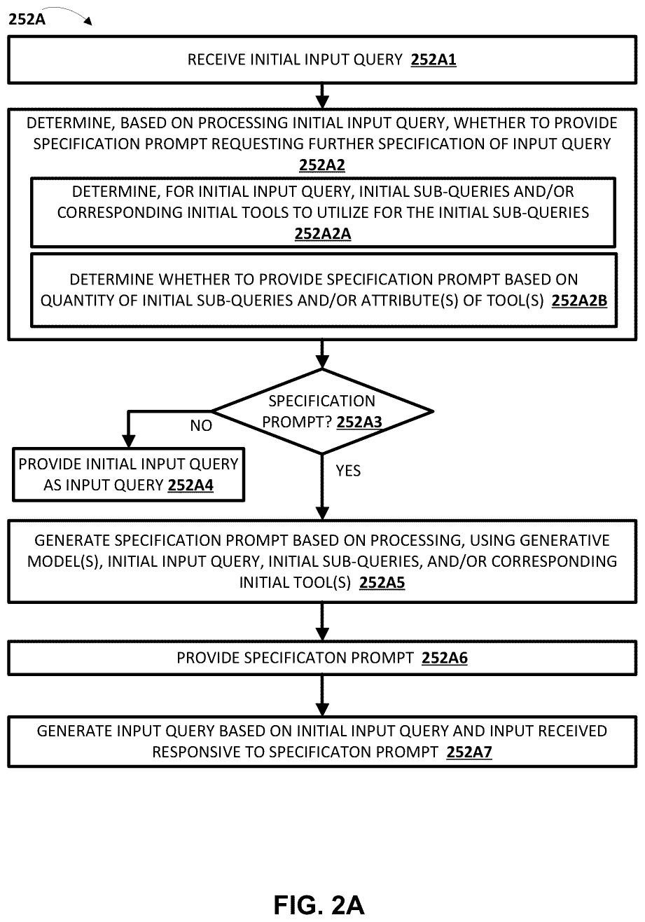

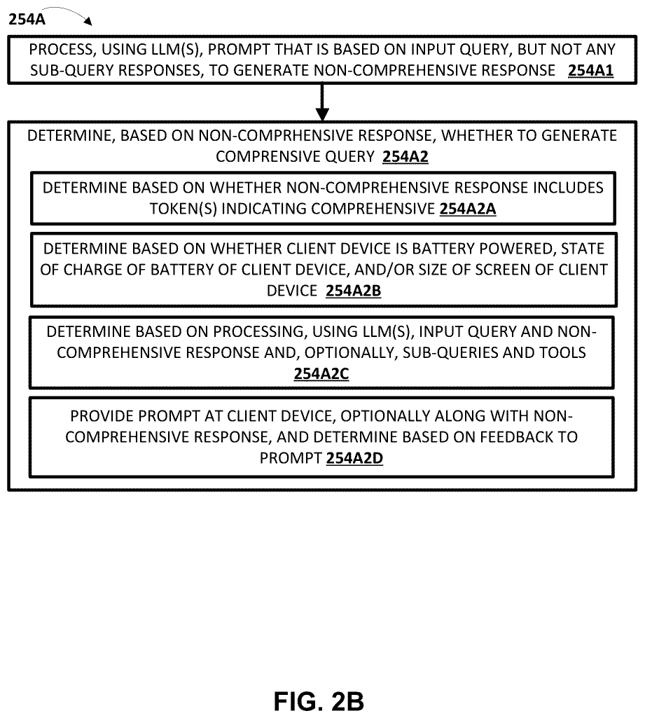

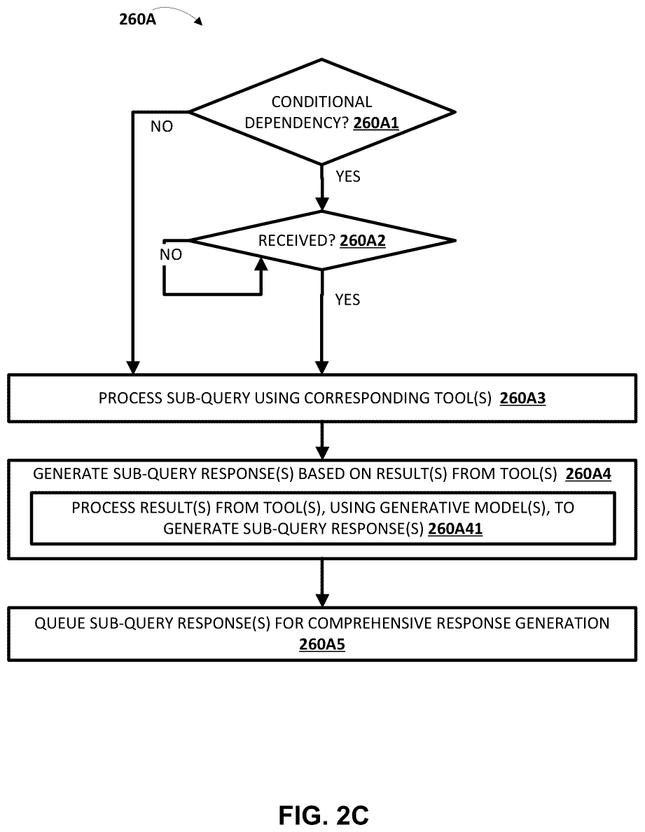

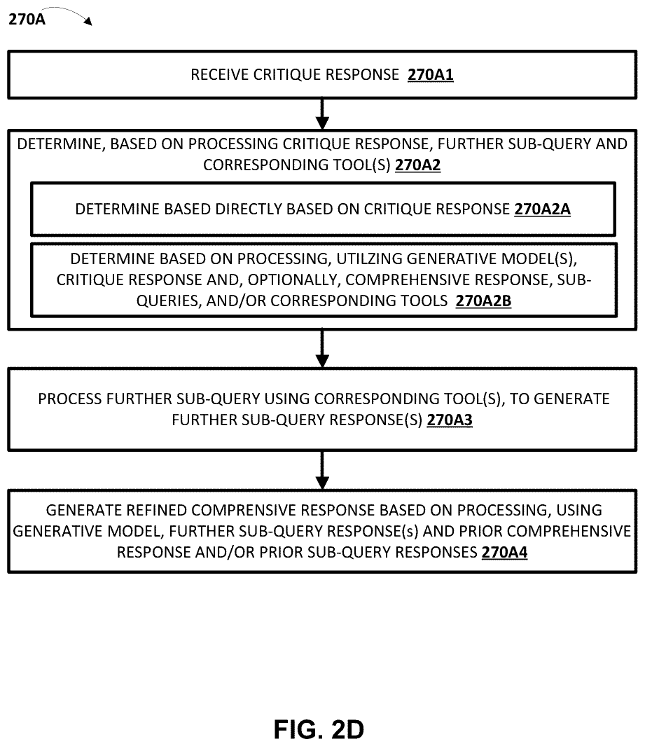

The triggering engine 130 can be configured to determine whether to generate a comprehensive response for a received input query. In some implementations, the triggering engine 130 can perform one or more aspects of block 254 of FIG. 2 (described below) and/or of implementation 254A of FIG. 2B (described below).

The decomposition engine 140 can be configured to decompose an input query into sub-queries and, for each of the sub-queries, one or more corresponding tools to utilize for the sub-query. In some implementations, the decomposition engine 140 can perform one or more aspects of block 258 of FIG. 2 (described below).

The tool engine 180 can be configured to cause sub-query responses to be generated for corresponding sub-queries and utilizing one or more corresponding tools, such as search tool 180A, browse tool 180B, call tool 180C, maps tool 180N, and/or other tool(s) (e.g. indicated by the ellipsis). In some implementations, the tool engine 180 can perform one or more aspects of block 260 of FIG. 2 (described below) and/or of implementation 260A of FIG. 2C (described below).

The comprehensive engine 150 can be configured to generate a comprehensive response, for a received input query, based on corresponding sub-query responses generated by the tool engine 180 based on a decomposition of the received input query. In some implementations, the comprehensive engine 150 can perform one or more aspects of block 258 of FIG. 2 (described below).

The critique engine 160 can be configured to generate a critique response, for a generated comprehensive response and determine, based on the critique response, whether to generate a refined comprehensive response. The critique engine 160 can be further configured to generate one or more further sub-queries and corresponding tool(s) based on the critique response, determine further sub-query response(s) based thereon (and optionally through interfacing with tool engine 180), and generate the refined comprehensive response (optionally through interfacing with comprehensive engine 150). In some implementations, the critique engine 160 can perform one or more aspects of block 270 of FIG. 2 (described below) and/or of implementation 270A of FIG. 2D (described below).

The UI engine 170 can be configured to generate data for audibly and/or graphically rendering of comprehensive responses, non-comprehensive responses, clarification prompt(s), sub-queries and/or tool(s) for the sub-queries (e.g., in presenting to a user prior to execution), and/or other outputs from response system 120. Such data can be provided to (e.g., transmitted via network(s) 199 to) rendering engine 112 and providing such data can cause, directly or indirectly, the rendering engine 112 to perform corresponding rendering.

Turning now to FIG. 2, a flowchart is depicted that illustrates an example method 200 of decomposing an input query into sub-queries and generating a comprehensive response based on responses to those subqueries. For convenience, the operations of method 200 are described with reference to a system that performs the operations. This system of method 200 includes one or more processors, memory, and/or other component(s) of computing device(s) (e.g., the response system 120 of FIG. 1). Moreover, while operations of method 200 are shown in a particular order, this is not meant to be limiting. One or more operations may be reordered, omitted, and/or added.

At block 252, the system receives an input query. The input query can be one formulated based on user interface input at a client device, such as typed input, voice input, input to cause an image to be captured or selected, etc. In some implementations, when the input includes content that is not in textual format, the system can convert the query to a textual format or other format. For example, if the user interface input is a voice query the system can perform automatic speech recognition (ASR) to convert the voice query into textual format.

In some implementations, in addition to including content that is based on user interface input at a client device, the input query of block 252 can include additional content that is based on measured and/or inferred feature(s) of the client device and/or the user. For example, the input query can include additional content that describes a location of the client device and/or additional content that describes explicit or inferred preferences of the user. For instance, the input query can include natural language text, that is provided by the client device along with the content that is based on the user interface input, and that describes a neighborhood, a city, and/or a state in which the client device is located. In some implementations, block 252 can include one or more aspects of the implementation 252A, of block 252, that is illustrated in FIG. 2A (described below).

At block 254, the system determines whether to generate and/or provide a comprehensive response responsive to the input query. For example, the system can determine whether to generate and/or provide a comprehensive response or to instead provide a non-comprehensive response responsive to the input query. In some implementations, block 254 can include one or more aspects of the implementation 254A, of block 254, that is illustrated in FIG. 2B (described below). In some implementations, block 254 can include determining whether user interface input has been provided that indicates an explicit desire for a comprehensive response to be generated and provided. For example, a “yes” determination can be made at block 254 in response to user interaction with a graphical element (e.g., a drop-down, a menu button, etc.) that indicates desire for a comprehensive response.

If, at block 254, the system determines to not provide the comprehensive response, the system proceeds to block 256 and provides a non-comprehensive response responsive to the input query. That is, the system proceeds to block 256 and causes the non-comprehensive response to be rendered at the client device responsive to the input query, and without performing one or more further blocks of method 200, such as not performing one or more of blocks 258, 260, 262, 264, 266, 268, and/or 270. As one example, the non-comprehensive response of block 256 can be one generated based on processing the input query utilizing an LLM and without any processing, utilizing the LLM and along with the input query, of any content generated based on any generated sub-queries and/or utilizing any tool(s). As another example, the non-comprehensive response of block 256 can be one generated based on processing the input query utilizing an LLM and processing, utilizing the LLM and along with the input query, content generated based on utilizing only a single tool.

Accordingly, block 256 is performed for at least some input queries when it is determined, based on one or more objective criteria (e.g., one or more of those described in FIG. 2B), that a non-comprehensive response should be provided in lieu of a comprehensive response. In these and other manners, non-comprehensive responses, which can be generated with greater computational efficiency and less latency, are at least selectively provided. However, according to method 200 and as described herein, comprehensive responses are generated and provided for at least some input queries. Further, such comprehensive responses, while requiring more computational resources and increased latency to generate relative to their non-comprehensive counterparts, can achieve various client device efficiencies as described herein.

If, at block 254, the system determines to provide the comprehensive response, the system proceeds to block 258 or block 260 (e.g., in implementations where block 258 has already been performed for use in the determination of block 254). At block 258, the system decomposes, using generative model(s), the input query to determine sub-queries and to determine corresponding tool(s) for each of the sub-queries.

As a working example, assume the input query is “I am in Louisville and want to replace my thermostat with a smart thermostat and my doorbells with smart doorbells by the end of the month”. The generated sub-queries and corresponding tools can include: a first query of “smart thermostat models” and a tool of “search”; a second query of “smart doorbell models” and the tool of “search”; a third query of “price and delivery date, to Louisville, for [smart thermostat model from response to first query]” and a tool of “browse”; a fourth query of “price and delivery date, to Louisville, for [smart doorbell model from response to second query]” and the tool of “browse”; a fifth query of “smart device installation in Louisville” and a tool of “maps”; a sixth query of “call [installation provider from response to fifth query] and determine available installation dates and times” and a tool of “call”; etc.

In this example, the tool of “search” can be an automated search tool that performs an internet search based on the sub-query and returns content (e.g., relevant snippet(s) of) from one or more of the top search results from the search. Accordingly, processing the first sub-query using the search tool can result in a sub-query response that includes snippet(s) that specify smart thermostat models and details for those models. Likewise, processing the second sub-query using the search tool can result in a sub-query response that includes snippet(s) that specify smart doorbell models and details for those models.

Further, in this example the tool of “browse” can be an automated browsing tool that automatically browses a specified website in accordance with a specified sub-query, or searches for and browses website(s) in accordance with a specified sub-query. Accordingly, processing the third sub-query (which is conditioned on the sub-query response for the first sub-query) using the tool of “browse” can cause searching for websites for each of the smart thermostat models of the sub-query response for the first sub-query, and browsing those websites (including optionally interacting with element(s) on those website(s)) to determine, for each of the smart thermostat models, corresponding price(s) and corresponding delivery date(s). The price(s) and delivery date(s), for each of the smart thermostat models of the sub-query response for the first sub-query, can be the sub-query response for the third sub-query. Likewise, processing the fourth query (which is conditioned on the sub-query response for the second sub-query) using the tool of “browser” can cause searching for websites for each of the smart doorbell models of the sub-query response for the second sub-query, and browsing those websites (including optionally interacting with element(s) on those website(s)) to determine, for each of the smart doorbell models, corresponding price(s) and corresponding delivery date(s).

Yet further, in this example the tool of “maps” can interact with a mapping system's application programming interface (API) to obtain map-based result(s) for a specified sub-query. Accordingly, a sub-query response for the fifth sub-query can include results, from the mapping system, for the fifth sub-query of “smart device installation in Louisville”. The tool of “call” can utilize automated calling technology, such as GOOGLE'S DUPLEX technology to place a corresponding automated call that is in accordance with the sixth sub-query. The sixth query is conditional on the sub-query response for the fifth sub-query, which can cause calls to be placed to each of the installation providers indicated in the sub-query response for the fifth sub-query to inquire about available installation dates and times. The sub-query response for the sixth query can be based on the responses, to the inquiries about available installation dates and times, provided in the various calls.

In some implementations, block 258 includes sub-blocks 258A and 258B. In sub-block 258A, the system processes the input query using one or more generative models to determine the sub-queries. For example, the system can process the input query using an LLM that is fine-tuned based on sub-query generation data. Also, for example, the system can process a prompt, that includes the input query and additional prompt text, using an LLM that is optionally fine-tuned based on sub-query generation data. For instance, the additional prompt text can include few shot example(s) of a query and corresponding sub-queries and/or can include instructional text such as: “given [input query] create a list of steps that would need to be taken to enable completion of one or more goals specified in [input query]” or “given [input query] output a directed graph with nodes of the graph being steps that would need to be taken to enable completion of one or more goals specified in [input query], and edges in the graph reflecting an order for performing the steps”. The sub-queries can be determined based on LLM output generated by such processing.

In sub-block 258B, the system processes the sub-queries, generated in sub-block 258A, using one or more generative models, to determine, for each of the sub-queries, corresponding tool(s) and, optionally, one or more dependencies on one or more other sub-queries. The one or more generative models, utilized in sub-block 258B, can be the same as or distinct from those used in sub-block 258A. For example, the system can process a prompt, that includes the sub-queries and additional prompt text, using an LLM that is optionally fine-tuned based on tool use data and/or sub-query dependency data. For instance, the additional prompt text can include few shot examples, descriptions of available tools, and/or instructional text such as “given [sub-queries] and [tool descriptions] specify, for each sub-query, which tool(s) should be utilized to generate a response to the sub-query and, if needed, modify the sub-query to be dependent on one or more responses from one or more other of the sub-queries”. The tool(s) and/or dependencies can be determined based on LLM output generated by such processing.

In some implementations, prior to proceeding to block 260, one or more (e.g., all) of the sub-queries determined at block 258A and/or one or more of the corresponding tool(s) determined at block 258B can be rendered (e.g., graphically) at a user interface output device of a client device via which the input query was received at block 252. In some of those implementations, a corresponding user can provide user interface input that is directed to such rendering to alter and/or remove one or more of the sub-queries and/or the corresponding tool(s). For example, the sub-queries and/or tools can be graphically rendered along with a selectable proceed graphical interface element and with one or more alteration or removal interface elements (e.g., a voice interface element for providing spoken utterance based alteration or removal instructions). If the proceed graphical interface element is selected (e.g., via explicit user interface input or through inaction after a time period has expired), the system can proceed to block 260 based on the sub-queries and tool(s). However, if interactions occur with alteration or removal interface elements, it can result in one or more sub-queries and/or one or more tools being altered or removed. Thereafter, the system can proceed to block 260 based on the resulting sub-queries and tool(s) from the alteration(s).

At block 260, the system, for each sub-query, causes processing of the sub-query, using corresponding tool(s), to generate corresponding sub-query response(s). In some implementations and/or for some tools, the system can cause processing of a sub-query using a tool by providing the sub-query to the corresponding tool via an API of the tool. In various implementations, when a given sub-query is dependent on a sub-query response for a separate sub-query, the system can, at block 260, await the sub-query response prior to causing the given sub-query to be processed using its corresponding tool(s). Further, the system can additionally refine the given sub-query, using the sub-query response on which it is dependent, prior to interacting with the tool(s) to cause processing of the sub-query. More generally, the system can, at block 260, coordinate the order and timing of processing of each of the sub-queries.

It is noted that, depending on the sub-queries and/or tools, block 260 can take seconds, minutes, hours, or even day(s) to fully complete. For example, processing of a query using a “browse” tool can, for at least some queries, take multiple seconds to complete. As another example, processing of a “call” tool can take minute(s) to complete, and may take hour(s) before it can be initiated (e.g., during open hour(s) for a corresponding business). Further, dependencies of sub-queries to other sub-queries can impact the time duration for completion. Yet further, in various implementations the system can, at block 260, purposefully delay processing of one or more queries so that such processing occurs during estimated or measured periods of lesser server load and/or periods of more abundant energy availability.

In some implementations, block 260 can include one or more aspects of the implementation 260A, of block 260, that is illustrated in FIG. 2C (described below). At block 262, the system processes, using one or more generative models, sub-query responses from block 260 to generate a comprehensive response. The one or more generative models, utilized in block 262, can be the same as or distinct from those used in block 258 and/or in block 260. For example, the system can process the sub-query responses using an LLM that is fine-tuned based on comprehensive response generation data. Also, for example, the system can process a prompt, that includes the sub-query responses and additional prompt text, using an LLM that is optionally fine-tuned based on comprehensive response generation data. For instance, the additional prompt text can include few shot example(s) of sub-queries and a corresponding comprehensive response and/or text such as “given [sub-query responses] create output that specifies a graphical user interface that conveys main components of the sub-query responses and that is organized in a logical manner”. The comprehensive response can be determined based on LLM output generated by such processing.

At block 264, the system processes, using one or more generative models, the input query and the comprehensive response to generate a critique response that indicates whether the comprehensive response is responsive to the input query. For example, the comprehensive response can be generated based on generative model output generated by such processing. The one or more generative models, utilized in block 264, can be the same as or distinct from those used in block 258, block 260, and/or block 262. For example, the system can process the input query and the comprehensive response using an LLM that is fine-tuned based on critique response generation data. Also, for example, the system can process a prompt that includes the input query and the comprehensive response, along with additional prompt text, using an LLM that is optionally fine-tuned based on critique response generation data. For instance, the additional prompt text can include few shot example(s) of input queries and comprehensive responses and a corresponding critique response and/or instructional text such as “is [comprehensive response] fully responsive to [input query]? If so, output ‘responsive’. If not, output a description of why it is not fully responsive”.

In some implementations, block 264 includes sub-block 264A in which the system processes, using the generative model and along with the input query and the comprehensive response, the sub-queries and/or the corresponding tools of block 258. For example, the system can process, using the generative model, a prompt such as “In generating [comprehensive response] to [input query] I used [sub-queries and corresponding tools]. Were there any additional sub-queries and corresponding tools I should have used? If not, output ‘responsive’. If so, output those sub-queries and corresponding tools that should have also been used”.

At block 266, the system determines, based on the critique response of block 264, whether the comprehensive response is responsive to the input query. For example, where the system, at block 264, prompts the generative model to output “responsive” or other responsive token when the comprehensive response is responsive to the input query, the system can determine it is responsive when the responsive token is included in the critique response and, otherwise, determine it is not responsive.

If, at block 266, the system determines the comprehensive response is responsive, the system proceeds to block 268 and provides the comprehensive response. For example, the system can cause the comprehensive response to be rendered (e.g., audibly and/or visually) at a client device, such as the client device via which the user interface input of block 252 was received. In some implementations, block 268 includes sub-block 268A where a push notification is provided to the client device to inform a user of availability of the comprehensive response. For example, the push notification can be provided if an application for rendering the comprehensive response is not active and selection of the push notification can cause the application to be launched in a state that renders the comprehensive response.

If, at block 266, the system determines the comprehensive response is not responsive, the system proceeds to block 270 and generates a refined comprehensive response that is based on a further sub-query response, where the further sub-query response is generated based on the critique response of a most recent iteration of block 264. For example, the critique response can directly indicate a further sub-query and further tool, or can be processed by the system, using a generative model, to determine a further sub-query and further tool. Further, the system can cause a further sub-query response to be generated, based on the further sub-query and the further tool, and generate the refined comprehensive response based on the further sub-query response. In some implementations, block 270 can include one or more aspects of the implementation 270A, of block 270, that is illustrated in FIG. 2D (described below).

In some implementations, following block 270 the system proceeds back to block 264 and performs block 264 based on the refined comprehensive response. In some other implementations, if a threshold quantity (e.g., 1, 2, 3 or other threshold) of iterations of blocks 264 and 266 have been performed, the system can proceed to block 268 after performing block 270 and cause, at block 268, the most recently generated refined comprehensive response to be provided. The threshold can be selected to balance the comprehensiveness of the comprehensive response with the computational resources needed to generate additional refined comprehensive responses.

FIG. 2A depicts a flowchart that illustrates an example implementation 252A of block 252 of FIG. 2.

At block 252A1, the system receives an initial input query, such as one that is based solely on user interface input at a client device and, optionally, contextual information provided along with such user interface input.

At block 252A2, the system determines, based on processing the initial input query, whether to provide a specification prompt requesting further specification of the input query. In some implementations, block 252A2 includes sub-blocks 252A2A and 252A2B.

At sub-block 252A2A, the system determines, for the initial input query, initial sub-queries and/or corresponding initial tools to utilize for the initial sub-queries. For example, the system can perform an iteration of block 258 (FIG. 2) based on the initial input query.

At sub-block 252A2B, the system determines whether to provide the specification prompt based on a quantity of the initial sub-queries and/or based on attribute(s) of the tool(s). The attribute(s) of the tool(s) can include, for example, computational resource usage required by the tool (e.g., average memory, processor, and/or bandwidth utilization) and/or temporal duration of utilizing the tool (e.g., average amount of time for the tool to generate a response to a query). In various implementations, at sub-block 252A2B, the system can determine to provide the specification prompt when the quantity of the initial sub-queries and/or the attribute(s) of the tools indicate anticipated resource utilization that is anticipated to exceed a threshold.

At block 252A3, the system determines to proceed to block 252A4 if it is determined to not provide a specification prompt, and proceeds to block 252A5 otherwise. At block 252A4, the system provides the initial input query as the input query.

At block 252A5, the system generates the specification prompt based on processing, using one or more generative models, the initial input query, the initial sub-queries, and/or the corresponding initial tool(s). For example, in generating the specification prompt the system can process, utilizing the LLM, a prompt of the form “I plan to use [initial sub-queries] in generating a response to [initial input query] provided by a user. Generate a question that, when answered by the user, can eliminate the need to use one or more of the [initial sub-queries]” and determine the specification prompt based on LLM output generated based on processing the prompt.

At block 252A6, the system provides the specification prompt. For example, the system can cause the specification prompt to be rendered at a client device at which user interface input, on which the initial input query is based, was provided.

At block 252A7, the system generates the input query based on the initial input query and input that is received responsive to the specification prompt. For example, in generating the input query the system can process, utilizing an LLM, a prompt of the form “Generate a refinement of [initial input query] provided by a user based on the user responding with [input] in response to being provided with [specification prompt]”, and can determine the input query based on LLM output generated based on processing the prompt.

In these and other manners, the implementation 252A of block 252 can be performed to cause specification prompts to be at least selectively provided. Further, input provided responsive to providing such specification prompts can enable generation of an input query that differs from the initial input query. Yet further, generating a comprehensive response to such input query can be more computationally efficient than generating a comprehensive response to the initial input query.

FIG. 2B depicts a flowchart that illustrates an example implementation 254A of block 254 of FIG. 2.

At block 254A1 the system processes, using one or more LLMs, a prompt that is based on the input query, but that is not based on any sub-query responses (e.g., not based on any of the sub-query responses of block 260 of FIG. 2), to generate a non-comprehensive response. For example, the non-comprehensive response can be determined based on LLM output from such processing.

At block 254A2 the system determines, based on the non-comprehensive response, whether to generate the comprehensive query. In some implementations block 254A2 includes sub-block(s) 254A2A, 254A2B, 254A2C, and/or 254A2D.

At sub-block 254A2A, the system determines whether to generate the comprehensive response based on whether the non-comprehensive response includes token(s) indicating comprehensiveness. For example, the LLM(s), utilized in sub-block 254A1 can be fine-tuned to cause, when an input query is appropriate for comprehensive response generation, generation of LLM output that reflects token(s) that indicate a comprehensive response. The system can be more likely to (or can always) generate a comprehensive response when the non-comprehensive response includes token(s) indicating comprehensive response generation.

At sub-block 254A2B, the system determines whether to generate the comprehensive response based on whether the client device, via which user interface input (on which the input query is based) is provided is battery powered, based on a state of charge of a battery of the client device (e.g., if an indication is provided along with the input query), and/or a size of a screen of the client device (e.g., if an indication provided along with the input query). For example, the system can be more likely to generate the comprehensive query when the device is battery powered, the state of charge is low, and/or the size of the screen is small. In these and other manners, the system can be more likely to generate a comprehensive response when doing so will achieve computational efficiencies that are beneficial to characteristic(s) of the client device.

At sub-block 254A2C, the system determines whether to generate the comprehensive response based on processing, using one or more LLMs, the input query and the non-comprehensive response and, optionally, one or more sub-queries and/or corresponding tools generated based on the input query. For example, the system can process, using an LLM, a prompt that is of the form “the initial response to [input query] is [non-comprehensive response] fully responsive to [input query]? If so, output ‘responsive’. If not, output ‘not fully responsive’”. The system can determine whether to generate the comprehensive response based on LLM output from such processing. For example, the system can be more likely to (or can always) generate a comprehensive response if the LLM output indicates “not fully responsive”.

At sub-block 254A2D, the system determines whether to generate the comprehensive response based on providing a prompt, at the client device, via which user interface input (on which the input query is based) is provided, and determine whether to generate the comprehensive query based on the feedback to the prompt. For example, the system can cause the non-comprehensive response to be provided along with a prompt that includes text of “would you like a more comprehensive response” and selectable interface elements of “yes” and “no”. If the feedback to the prompt is selection of the “yes” interface element, or speaking or typing of “yes”, the system can determine to generate the comprehensive response.

FIG. 2C depicts a flowchart that illustrates an example implementation 260A of block 260 of FIG. 2. FIG. 2C illustrates example steps that can be performed in handling each of the sub-queries and corresponding tool(s) in an iteration of block 260 of FIG. 2.

At block 260A1, the system determines whether a sub-query being processed has a conditional dependency (e.g., conditioned on sub-query response(s) for one or more other sub-queries). If not, the system proceeds to block 260A3. If so, the system proceeds to block 260A2. At block 260A2, the system waits for the sub-query response(s), on which the sub-query is conditioned, to be received. Once received, the system proceeds to block 260A3.

At block 260A3, the system processes the sub-query (optionally refined with any dependencies) using one or more corresponding tools. This can include causing the sub-query to be processed by the corresponding tool(s), optionally through interaction with API(s) of the corresponding tool(s).

At block 260A4, the system generates one or more sub-query response based on result(s) from the tool(s) from block 260A3. In some implementations, block 260A4 include sub-block 260A41 in which the system processes the result(s) from the tool(s), using generative model(s), to generate the sub-query response(s). For example, the system can process, using an LLM, a prompt of the form “generate a shortened version of [sub-query responses] that maintains key facts”, and generate a single sub-query response based on LLM output from such processing. As another example, the system can process, using an LLM, a prompt of the form “generate a table that reflects the data in [sub-query responses]”, and generate a single sub-query response based on LLM output from such processing. As yet another example, the system can process, using an image generation model, a prompt of the form “realistic image that reflects [sub-query responses]”, and include, in the sub-query response(s), an image generated based on such processing.

At block 260A5, the system queues the sub-query response(s) for comprehensive response generation. For example, can store the sub-query response(s) in memory for utilization, in block 262 of FIG. 2, when sub-query responses have been generated for all sub-queries.

FIG. 2D depicts a flowchart that illustrates an example implementation 270A of block 270 of FIG. 2.

At block 270A1, the system receives a critique response, such as one generated based on block 262 of FIG. 2.

At block 270A2, the system determines, based on processing the critique response, a further sub-query and corresponding tool(s) for the sub-query. In some implementations, block 270A2 includes sub-block 270A2A or sub-block 270A2B.

At sub-block 270A2A, the system determines the further sub-query and the corresponding tool(s) for the sub-query directly from the critique response. That is, the critique response itself can specify the further sub-query and the corresponding tool(s) for the sub-query.

At sub-block 270A2B, the system determines the further sub-query and the corresponding tool(s) based on processing, utilizing one or more generative models, the critique response and, optionally, the comprehensive response and/or the sub-queries and/or corresponding tool(s) utilized in generating the comprehensive response. For example, the system can process, using an LLM, a prompt of the form “the [comprehensive response] is not fully responsive due to [critique response], output a sub-query, and a tool to utilize in processing the sub-query, that will generate missing information flagged by [critique response]”, and can determine the further sub-query and the corresponding tool(s) based on LLM output from such processing.

At block 270A3, the system processes the further sub-query, using the corresponding tool(s), to generate a further sub-query response. For example, the system can interface with API(s) of the corresponding tool(s), based on the further sub-query, to cause the corresponding tool(s) to generate the further sub-query response.

At block 270A4, the system generates a refined comprehensive response based on processing, using a generative model, the further sub-query response(s) of block 270A3 and the prior comprehensive response and/or the prior sub-query response(s) (i.e., those utilized in generating the prior comprehensive response). For example, the system can process, using an LLM, a prompt of the form “generate a refined response that incorporates [further sub-query response(s)] into [prior comprehensive response]”, and can determine the refined comprehensive response based on LLM output from such processing.

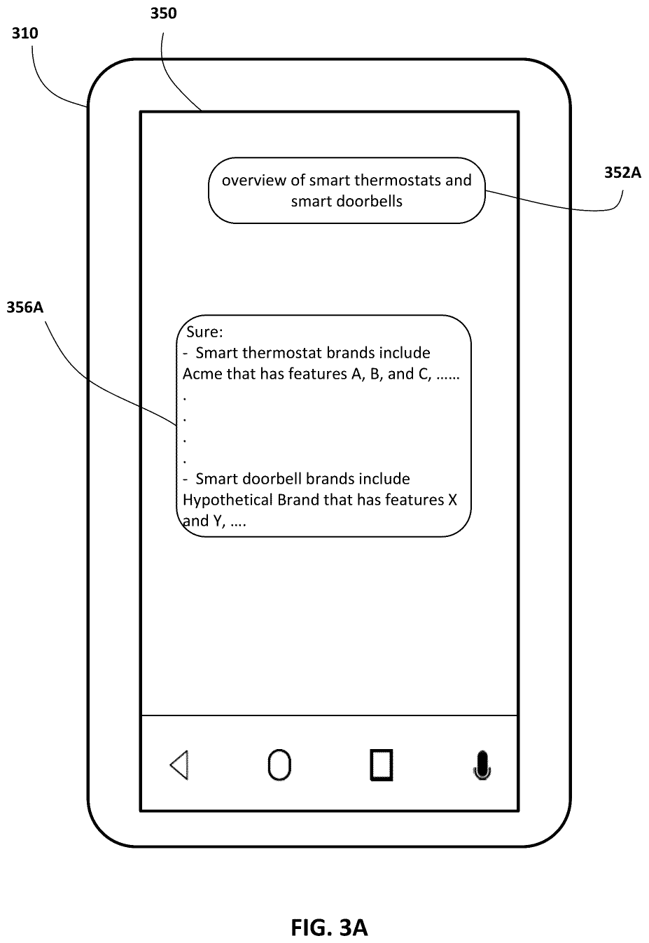

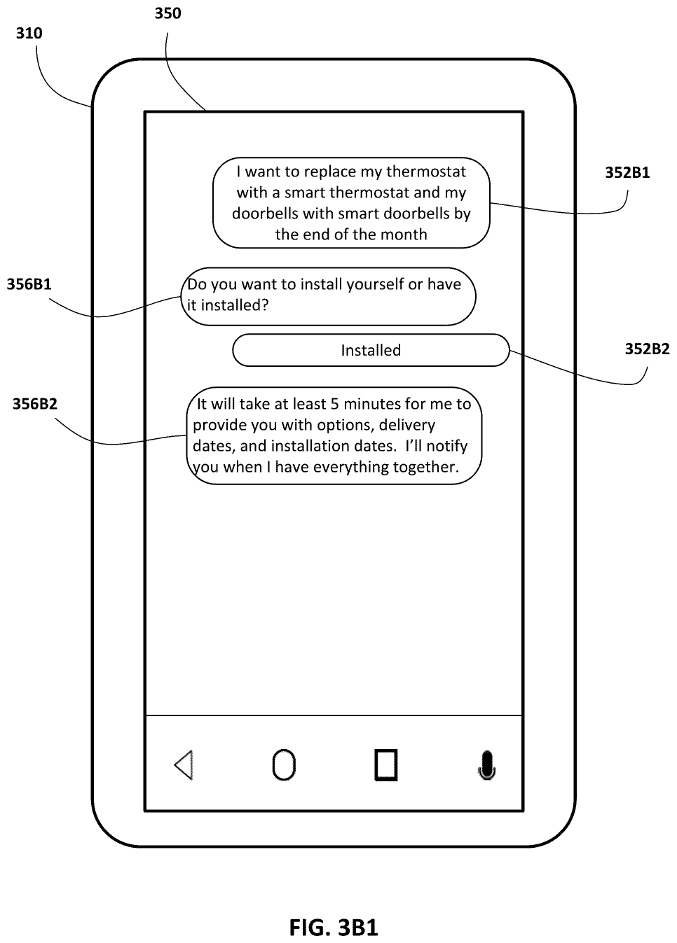

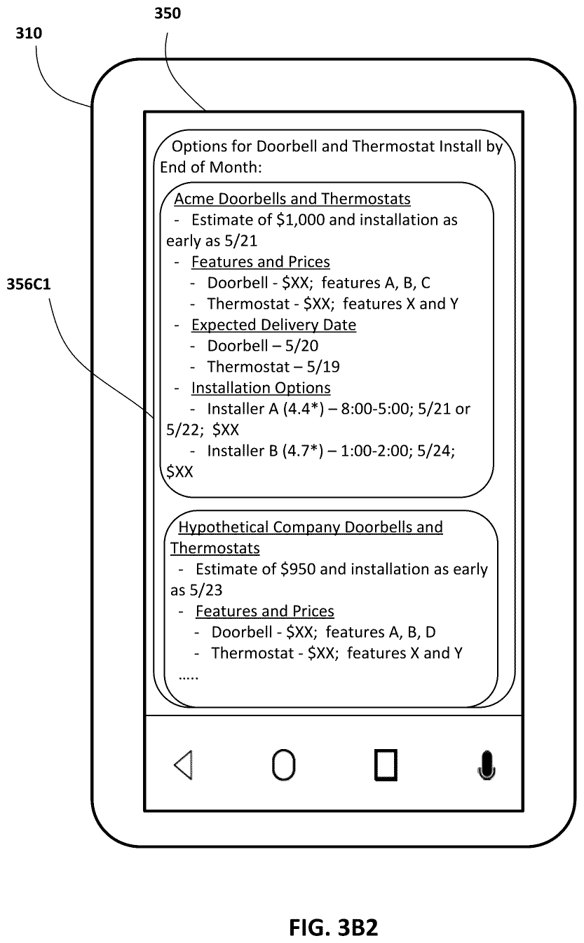

Turning now to FIGS. 3A, 3B1, and 3B2, an example client device 310 with a display 350 rendering a graphical interface is depicted.

FIG. 3A illustrates the example client device 310, an example input query 352A, and an example non-comprehensive response 356A that is provided responsive to the input query 356A. Accordingly, FIG. 3A illustrates a non-limiting example where, in method 200, a “no” decision is made at block 254, leading to block 256 being performed.

FIG. 3B1 illustrates the example client device 310, an example input query 352B1, an example specification prompt 356B1, an example user reply 365B2 to the specification prompt 365B1, and an example notification 356B2 that characterizes that there will be a time delay before a comprehensive response is provided, and that characterizes an anticipated duration of the time delay (5 minutes). Accordingly, FIG. 3A illustrates a non-limiting example where, in method 200, a “yes” decision is made at block 254 and, further, where implementation 252A (FIG. 2A) of block 252 is performed. For example, the specification prompt 356B1 can be generated based on implementation 252A (FIG. 2A) of block 252 and, further, an input query, that differs from the initial input query 352B1, can be generated based on the user reply 365B2 and based on implementation 252A (FIG. 2A) of block 252.

FIG. 3B2 illustrates the example client device 310 rendering a comprehensive response 365C1 and subsequent to the interaction of FIG. 3B1. For example, the comprehensive response 365C1 can be rendered after a delay, such as a 5 minute delay, during which other blocks of method 200 are performed in generating the comprehensive response 365C1. Notably, the comprehensive response can be generated based on an input query that differs from the initial input query 352B1 and that is generated based on the user reply 365B2 and based on implementation 252A (FIG. 2A) of block 252.

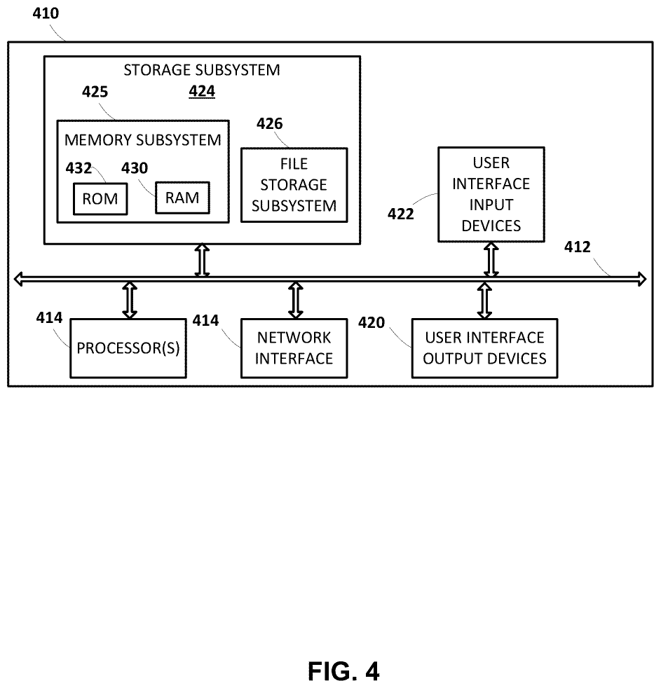

Turning now to FIG. 4, a block diagram of an example computing device 410 that may optionally be utilized to perform one or more aspects of techniques described herein is depicted. In some implementations, one or more of a client device, cloud-based automated assistant component(s), and/or other component(s) may comprise one or more components of the example computing device 410.

Computing device 410 typically includes at least one processor 414 which

communicates with a number of peripheral devices via bus subsystem 412. These peripheral devices may include a storage subsystem 424, including, for example, a memory subsystem 625 and a file storage subsystem 426, user interface output devices 420, user interface input devices 422, and a network interface subsystem 416. The input and output devices allow user interaction with computing device 410. Network interface subsystem 416 provides an interface to outside networks and is coupled to corresponding interface devices in other computing devices.

User interface input devices 422 may include a keyboard, pointing devices such as a mouse, trackball, touchpad, or graphics tablet, a scanner, a touch screen incorporated into the display, audio input devices such as voice recognition systems, microphones, and/or other types of input devices. In general, use of the term “input device” is intended to include all possible types of devices and ways to input information into computing device 410 or onto a communication network.

User interface output devices 420 may include a display subsystem, a printer, a fax machine, or non-visual displays such as audio output devices. The display subsystem may include a cathode ray tube (CRT), a flat-panel device such as a liquid crystal display (LCD), a projection device, or some other mechanism for creating a visible image. The display subsystem may also provide non-visual display such as via audio output devices. In general, use of the term “output device” is intended to include all possible types of devices and ways to output information from computing device 410 to the user or to another machine or computing device.

Storage subsystem 424 stores programming and data constructs that provide the functionality of some, or all, of the modules described herein. For example, the storage subsystem 424 may include the logic to perform selected aspects of the methods disclosed herein, as well as to implement various components depicted in FIG. 1.

These software modules are generally executed by processor 414 alone or in combination with other processors. Memory 425 used in the storage subsystem 424 can include a number of memories including a main random access memory (RAM) 430 for storage of instructions and data during program execution and a read only memory (ROM) 432 in which fixed instructions are stored. A file storage subsystem 626 can provide persistent storage for program and data files, and may include a hard disk drive, a floppy disk drive along with associated removable media, a CD-ROM drive, an optical drive, or removable media cartridges. The modules implementing the functionality of certain implementations may be stored by file storage subsystem 426 in the storage subsystem 424, or in other machines accessible by the processor(s) 414.

Bus subsystem 412 provides a mechanism for letting the various components and subsystems of computing device 410 communicate with each other as intended. Although bus subsystem 412 is shown schematically as a single bus, alternative implementations of the bus subsystem 412 may use multiple busses.

Computing device 410 can be of varying types including a workstation, server, computing cluster, blade server, server farm, or any other data processing system or computing device. Due to the ever-changing nature of computers and networks, the description of computing device 410 depicted in FIG. 4 is intended only as a specific example for purposes of illustrating some implementations. Many other configurations of computing device 410 are possible having more or fewer components than the computing device depicted in FIG. 4. In situations in which the systems described herein collect or otherwise monitor

personal information about users, or may make use of personal and/or monitored information), the users may be provided with an opportunity to control whether programs or features collect user information (e.g., information about a user's social network, social actions or activities, profession, a user's preferences, or a user's current geographic location), or to control whether and/or how to receive content from the content server that may be more relevant to the user. Also, certain data may be treated in one or more ways before it is stored or used, so that personal identifiable information is removed. For example, a user's identity may be treated so that no personal identifiable information can be determined for the user, or a user's geographic location may be generalized where geographic location information is obtained (such as to a city, ZIP code, or state level), so that a particular geographic location of a user cannot be determined. Thus, the user may have control over how information is collected about the user and/or used.

In some implementations a method implemented by processor(s) is provided and includes receiving an input query that is generated based on user interface input at a client device. The method further includes decomposing the input query. Decomposing the input query can include processing the input query, using a first generative model and/or a second generative model, to determine a plurality of sub-queries and, for each of the sub-queries, one or more corresponding tools to utilize in processing the sub-query. The method can further include, for each of the sub-queries, processing the sub-query, using the one or more corresponding tools for the sub-query, to generate one or more corresponding sub-query responses. The method can further include generating an initial comprehensive response to the input query. Generating the initial comprehensive response can include processing, using the first generative model, the second generative model, or a third generative model, the one or more corresponding sub-query responses for each of the sub-queries. The method can further include determining whether the initial comprehensive response is responsive to the input query. Determining whether the initial comprehensive response is responsive to the input query can include: (i) processing, using the first generative model, the second generative model, the third generative model, or a fourth generative model, the input query and the initial comprehensive response to generate a critique response that indicates whether the initial comprehensive response is responsive to the input query; and (ii) determining, based on the critique response, whether the initial comprehensive response is responsive to the input query. The method can further include, in response to determining that the initial comprehensive response is responsive to the input query, causing the initial comprehensive response to be rendered at the client device as responsive to the input query. The method can further include, in response to determining that the initial comprehensive response is not responsive to the input query: generating a refined comprehensive response that is based on a further sub-query response that is generated based on the critique response; and causing the refined comprehensive response to be rendered at the client device as responsive to the input query.

These and other implementations disclosed herein can include one or more of the following features.

In some implementations, generating the refined comprehensive response, that is based on the further sub-query response, includes: determining, based on the critique response, a further sub-query and one or more further tools to utilize in processing the further sub-query; processing the further sub-query, using the one or more further tools for the further sub-query, to generate one or more further sub-query responses; and generating the refined comprehensive response based on processing, using the first generative model, the second generative model, or the third generative model, the one or more further subquery responses and the initial comprehensive response or the one or more corresponding sub-query responses for each of the sub-queries. In some versions of those implementations, the method further includes determining whether the refined comprehensive response is responsive to the input query. Determining whether the refined comprehensive response is responsive to the input query can include: processing, using the first generative model, the second generative model, the third generative model, or the fourth generative model, the input query and the refined comprehensive response to generate an additional critique response that indicates whether the refined comprehensive response is responsive to the input query; and determining, based on the critique response, whether the refined comprehensive response is responsive to the input query; where causing the refined comprehensive response to be rendered at the client device as responsive to the input prompt is in response to determining that the refined comprehensive response is responsive to the input query. In some additional or alternative versions of those implementations, the critique response directly indicates one or both of the further sub-query and the one or more further tools to utilize in processing the further sub-query or, instead, the method further includes determining, based on processing the critique response, the further sub-query and the one or more further tools to utilize in processing the further sub-query.

In some implementations, processing, using the first generative model, the second generative model, or the third generative model, the input query and the initial comprehensive response to generate the critique response that indicates whether the initial comprehensive response is responsive to the input query further includes processing, using the first generative model, the second generative model, or the third generative model, and along with the input query and the initial comprehensive response: each of the sub-queries, each of the corresponding tools utilized in processing the sub-queries, and/or each of the corresponding sub-query responses.

In some implementations, the method further includes determining whether to provide an LLM-only response to the input query in lieu of a comprehensive response. In those implementations, generating the initial comprehensive response is performed responsive to determining to not provide the LLM-only response to the input query. In some versions of those implementations, the method further includes, prior to generating the initial comprehensive response, generating the LLM-only response based on processing, in a single LLM pass, an LLM prompt that is based on the input query. In those versions, determining whether to provide the LLM-only response to the input query in lieu of the comprehensive response includes processing the LLM-only response. In some additional or alternative versions of those implementations, processing the LLM-only response in determining whether to provide the LLM-only response to the input query in lieu of the comprehensive response includes: processing, using the first generative model, the second generative model, the third generative model, or the fourth generative model, the input query and the LLM-only response to generate an initial critique response that indicates whether the LLM-only response is responsive to the input query; and determining, based on the initial critique response, whether to provide the LLM-only response to the input query in lieu of the comprehensive response. In some of those additional or alternative versions, processing, using the first generative model, the second generative model, the third generative model, or the fourth generative model, the input query and the LLM-only response to generate the initial critique response further includes processing, using the first generative model, the second generative model, the third generative model, or the fourth generative model, and along with the input query and the LLM-only response: each of the sub-queries and/or each of the corresponding tools utilized in processing the sub-queries.

In some implementations, the method further includes, prior to processing each of the sub-queries to generate the corresponding sub-prompt responses causing a prompt to be rendered, at the client device, that characterizes the plurality of sub-queries and determining that affirmative user interface input is received responsive to the prompt. In those implementations, processing each of the sub-queries to generate the corresponding sub-prompt responses is contingent on receiving the affirmative user interface input. In some of those implementations, the prompt further characterizes the corresponding tools for the plurality of sub-queries.

In some implementations, the method further includes, prior to or while processing each of the sub-queries to generate the corresponding sub-query responses, causing a notification to be rendered, at the client device, that characterizes that there will be a time delay before a comprehensive response is provided. In these and other manners a user of the client device is notified there will be a time delay and can enable the client device to go into a standby or other lower power mode. In some of those implementations, the notification further characterizes an anticipated duration of the time delay. For example, the method can further include determining the anticipated duration of the time delay as a function of at least one of the corresponding tools. For instance, the anticipated duration of the time delay can be based on an average time for utilization of one or more of the corresponding tools, such as the highest average time amongst all of the corresponding tools. In these and other manners a user of the client device is notified of the extent of the time delay and can enable the client device to go into a standby or other lower power mode for that extent.

In some implementations, the plurality of sub-queries include a first sub-query and a second sub-query that is distinct from the first sub-query and wherein the corresponding tools include a first tool to utilize in processing the first sub-query and a second tool, that is distinct from the first tool, to utilize in processing the second sub-query. In some of those implementations, the first tool is one of a search tool, an automated web browsing tool, a maps tool, an LLM-only tool, an automated calling tool, and a news tool and the second tool is a distinct one of the search tool, the automated web browsing tool, the maps tool, the LLM-only tool, the automated calling tool, and the news tool. The LLM-only tool can utilize an LLM without any invocation of any external tool.

In some implementations, the plurality of sub-queries include a first sub-query and a second sub-query that is distinct from the first sub-query and that is conditioned on the corresponding sub-query response generated based on the first sub-query.

In some implementations, decomposing the input query includes processing the input query, using the first generative model, to determine the plurality of sub-queries and processing the plurality of sub-queries, using the second generative model, to generate the one or more corresponding tools to utilize in processing each of the sub-queries and, optionally, to generate any conditional dependencies between one or more of the sub-queries.

In some implementations, receiving the input query includes: receiving an initial input query that is generated based on initial user interface input at the client device; causing a specification prompt to be provided, at the client device, requesting further specification of the initial input query; receiving a refinement of the initial input query that is based on further user interface input provided responsive to the specification prompt; and generating the input query based on the refinement and the initial input query. In some versions of those implementations, the method further includes determining, based on processing the initial input query, to provide the specification prompt-and causing the specification prompt to be provided is in response to determining, based on processing the initial input query, to provide the specification prompt. In some of those versions, processing the initial input query includes decomposing the initial input query, using the first generative model and/or the second generative model, to determine a plurality of initial sub-queries, and/or for each of the initial sub-queries, one or more corresponding initial tools to utilize in processing the initial sub-query. Optionally, in some of those versions determining, based on processing the initial input query, to provide the specification prompt, includes determining to provide the specification prompt based on a quantity of the initial sub-queries and/or one or more attributes of the corresponding initial tools.

In some implementations, the method further includes determining, based on one or more properties of the client device, to generate a comprehensive response to the input query and generating the initial comprehensive response is performed responsive to determining to generate the comprehensive response. In some of those implementations, the one or more properties include whether the client device is battery powered, an inferred or actual size of a screen of the client device, and/or an inferred or actual state of charge of a battery of the client device.

In addition, some implementations include one or more processors (e.g., central processing unit(s) (CPU(s)), graphics processing unit(s) (GPU(s), and/or tensor processing unit(s) (TPU(s)) of one or more computing devices, where the one or more processors are operable to execute instructions stored in associated memory, and where the instructions are configured to cause performance of any of the aforementioned methods. Some implementations also include one or more transitory or non-transitory computer readable storage media storing computer instructions executable by one or more processors to perform any of the aforementioned methods. Some implementations also include a computer program product including instructions executable by one or more processors to perform any of the aforementioned methods.

What is claimed is:

1. A method implemented by one or more processors, the method comprising:
receiving an input query that is generated based on user interface input at a client device;
decomposing the input query, decomposing the input query comprising processing the input query, using a first generative model and/or a second generative model, to determine:
a plurality of sub-queries, and
for each of the sub-queries, one or more corresponding tools to utilize in processing the sub-query;
for each of the sub-queries:
processing the sub-query, using the one or more corresponding tools for the sub-query, to generate one or more corresponding sub-query responses;
generating an initial comprehensive response to the input query, generating the initial comprehensive response comprising processing, using the first generative model, the second generative model, or a third generative model, the one or more corresponding sub-query responses for each of the sub-queries;
determining whether the initial comprehensive response is responsive to the input query, determining whether the initial comprehensive response is responsive to the input query comprising:
processing, using the first generative model, the second generative model, the third generative model, or a fourth generative model, the input query and the initial comprehensive response to generate a critique response that indicates whether the initial comprehensive response is responsive to the input query; and
determining, based on the critique response, whether the initial comprehensive response is responsive to the input query;
in response to determining that the initial comprehensive response is responsive to the input query:
causing the initial comprehensive response to be rendered at the client device as responsive to the input query; and
in response to determining that the initial comprehensive response is not responsive to the input query:
generating a refined comprehensive response that is based on a further sub-query response, the further sub-query response being generated based on the critique response; and
causing the refined comprehensive response to be rendered at the client device as responsive to the input query.

2. The method of claim 1, wherein generating the refined comprehensive response, that is based on the further sub-query response, comprises:
determining, based on the critique response, a further sub-query and one or more further tools to utilize in processing the further sub-query;
processing the further sub-query, using the one or more further tools for the further sub-query, to generate one or more further sub-query responses;
generating the refined comprehensive response based on processing, using the first generative model, the second generative model, or the third generative model, the one or more further subquery responses and the initial comprehensive response or the one or more corresponding sub-query responses for each of the sub-queries.

3. The method of claim 2, further comprising:
determining whether the refined comprehensive response is responsive to the input query, determining whether the refined comprehensive response is responsive to the input query comprising:
processing, using the first generative model, the second generative model, the third generative model, or the fourth generative model, the input query and the refined comprehensive response to generate an additional critique response that indicates whether the refined comprehensive response is responsive to the input query; and
determining, based on the critique response, whether the refined comprehensive response is responsive to the input query;
wherein causing the refined comprehensive response to be rendered at the client device as responsive to the input prompt is in response to determining that the refined comprehensive response is responsive to the input query.

4. The method of claim 2, wherein the critique response directly indicates one or both of the further sub-query and the one or more further tools to utilize in processing the further sub-query.

5. The method of claim 2, further comprising:
determining, based on processing the critique response, the further sub-query and the one or more further tools to utilize in processing the further sub-query.

6. The method of claim 1, wherein processing, using the first generative model, the second generative model, or the third generative model, the input query and the initial comprehensive response to generate the critique response that indicates whether the initial comprehensive response is responsive to the input query further comprises:
processing, using the first generative model, the second generative model, or the third generative model, and along with the input query and the initial comprehensive response:
each of the sub-queries,
each of the corresponding tools utilized in processing the sub-queries, and/or
each of the corresponding sub-query responses.

7. The method of claim 1, further comprising:
determining whether to provide an LLM-only response to the input query in lieu of a comprehensive response;
wherein generating the initial comprehensive response is performed responsive to determining to not provide the LLM-only response to the input query.

8. The method of claim 7, further comprising:
prior to generating the initial comprehensive response:
generating the LLM-only response based on processing, in a single LLM pass, an LLM prompt that is based on the input query;
wherein determining whether to provide the LLM-only response to the input query in lieu of the comprehensive response comprises processing the LLM-only response.

9. The method of claim 7, wherein processing the LLM-only response in determining whether to provide the LLM-only response to the input query in lieu of the comprehensive response comprises:
processing, using the first generative model, the second generative model, the third generative model, or the fourth generative model, the input query and the LLM-only response to generate an initial critique response that indicates whether the LLM-only response is responsive to the input query; and
determining, based on the initial critique response, whether to provide the LLM-only response to the input query in lieu of the comprehensive response.

10. The method of claim 9, wherein processing, using the first generative model, the second generative model, the third generative model, or the fourth generative model, the input query and the LLM-only response to generate the initial critique response further comprises:
processing, using the first generative model, the second generative model, the third generative model, or the fourth generative model, and along with the input query and the LLM-only response:
each of the sub-queries, and/or
each of the corresponding tools utilized in processing the sub-queries.

11. The method of claim 1, further comprising:
prior to processing each of the sub-queries to generate the corresponding sub-prompt responses:
causing a prompt to be rendered, at the client device, that characterizes the plurality of sub-queries; and
determining that affirmative user interface input is received responsive to the prompt;
wherein processing each of the sub-queries to generate the corresponding sub-prompt responses is contingent on receiving the affirmative user interface input.

12. The method of claim 11, wherein the prompt further characterizes the corresponding tools for the plurality of sub-queries.

13. The method of claim 1, further comprising:
prior to or while processing each of the sub-queries to generate the corresponding sub-query responses:
causing a notification to be rendered, at the client device, that characterizes that there will be a time delay before a comprehensive response is provided.

14. The method of claim 13, wherein the notification further characterizes an anticipated duration of the time delay.

15. The method of claim 14, further comprising:
determining the anticipated duration of the time delay as a function of at least one of the corresponding tools.

16. The method of claim 1, wherein the plurality of sub-queries include a first sub-query and a second sub-query that is distinct from the first sub-query and wherein the corresponding tools include a first tool to utilize in processing the first sub-query and a second tool, that is distinct from the first tool, to utilize in processing the second sub-query.

17. The method of claim 1, wherein the plurality of sub-queries include a first sub-query and a second sub-query that is distinct from the first sub-query and that is conditioned on the corresponding sub-query response generated based on the first sub-query.

18. The method of claim 1, wherein receiving the input query comprises:
receiving an initial input query that is generated based on initial user interface input at the client device;
causing a specification prompt to be provided, at the client device, requesting further specification of the initial input query;
receiving a refinement of the initial input query that is based on further user interface input provided responsive to the specification prompt; and
generating the input query based on the refinement and the initial input query.

19. The method of claim 18, further comprising:
determining, based on processing the initial input query, to provide the specification prompt;
wherein causing the specification prompt to be provided is in response to determining, based on processing the initial input query, to provide the specification prompt.

20. The method of claim 1, further comprising:
determining, based on one or more properties of the client device, to generate a comprehensive response to the input query;
wherein generating the initial comprehensive response is performed responsive to determining to generate the comprehensive response.
